(19) United States
(12) Patent Application Publication
(10) Pub. No.: US 2020/0324677 A1
(43) Pub. Date: Oct. 15, 2020

(54) METHOD FOR CONTROLLING A MOTOR OF A MASSAGE UNIT PROVIDED IN A SEAT, CONTROL DEVICE, AND SEAT ARRANGEMENT

(71) Applicant: BROSE FAHRZEUGTEILE GMBH & CO. KOMMANDITGESELLSCHAFT, COBURG, Coburg (DE)

(72) Inventors: Christian MERGL, Zeil/Main (DE); Wojciech FALINSKI, Coburg (DE); Wolfgang UEBEL, Weitramsdorf (DE); Christian KARL, Coburg (DE); Christian HERRMANN, Coburg (DE); Martin JUERGENLIEMK, Untersiemau (DE)

(73) Assignee: BROSE FAHRZEUGTEILE GMBH & CO. KOMMANDITGESELLSCHAFT, COBURG, Coburg (DE)

(21) Appl. No.: 16/087,977

(22) PCT Filed: Mar. 20, 2017
(86) PCT No.: PCT/EP2017/056545

§ 371 Date: Oct. 30, 2018

(30) Foreign Application Priority Data
Mar. 23, 2016 (DE) 10 2016 204 845.7

(51) Int. Cl. B60N 2/90; A61H 23/02

(52) U.S. Cl. CPC B60N 2/976; A61H 23/0263; A61H 2201/5092; A61H 2201/5007; A61H 2201/1215

(57) ABSTRACT

The invention relates to a method for controlling a motor (20) of a massage unit (2) provided in a seat (10), in particular a vehicle seat, wherein the control is undertaken based on a primary signal (4) and a secondary signal, wherein the primary signal is an entertainment signal and wherein the secondary signal is based on at least one state parameter of the motor. The invention further relates to a control device, which is designed to control the motor according to such a method, and to a seat arrangement having a seat, having a motor provided in the seat, and having such a control device.

### CROSS-REFERENCE TO RELATED APPLICATIONS

This application is the U.S. National Phase of PCT/EP2017/056545 filed Mar. 20, 2017, which claims priority to DE 10 2016 204 845.7 filed Mar. 23 2016, the entire disclosures of which are hereby incorporated in their entirety by reference herein.

### TECHNICAL FIELD

The present invention relates to a method for controlling a motor of a massage unit provided in a seat, in particular a vehicle seat, and a control device for executing such a method and a corresponding seat assembly.

### BACKGROUND

Although any type of seat can be used, the present invention and the fundamental problems addressed by the invention shall be explained in greater detail on the basis of a vehicle seat.

Massage system for vehicle seats exist in which an occupant can choose between different massage programs. Such a massage system is described by way of example in DE 297 05530 U1.

Until now, such massage systems are normally only used intermittently. Service life demands for such massage systems are therefore significantly lower than for vehicle components that are continuously in use.

Currently, there are attempts to couple massage systems in a vehicle to other vehicle systems in order to improve the driver's experience. Such a concept is described by way of example in DE 10 2015 109067 A1.

When a massage system is coupled to a vehicle system configured for a long service life, e.g. an entertainment system of a vehicle, the service life demands on the coupled components are thus different.

### SUMMARY

With this background, the fundamental object of the invention is to produce an improved method for controlling a motor of a massage unit provided in a seat.

This problem is solved according to the invention by a method that has the features of claim 1 and/or by a seat assembly that has the features of claim 15.

Accordingly, provided are:

A method for controlling a motor of a massage unit provided in a seat, in particular a vehicle seat, wherein the control is undertaken on the basis of a primary signal and a secondary signal, wherein the primary signal is an entertainment signal and wherein the secondary signal is based on at least one motor state variable.

A control device configured for controlling at least one motor in accordance with a method according to the invention.

A seat assembly, in particular for a vehicle, that has: a seat, in particular a vehicle seat; a motor for a massage unit provided in the seat; and a control device according to the invention, provided for controlling the motor.

The fundamental problem addressed by the present invention is that, with a coupling of a massage system to an entertainment system, both the service life as well as the noise emissions created by the massage system must be adapted to those of the entertainment system.

The fundamental idea of the present invention is therefore to adapt the service life and the noise emissions of a massage system in equal measure to an entertainment system through a secondary control of the motor based on at least one motor state variable. For this, control is undertaken based on both a primary signal, which is an entertainment signal of the entertainment system, and a secondary signal, which is based on at least one motor state variable. In this manner, the service life of the motor is advantageously increased according to the invention, and at the same time, undesired noise emissions are reduced.

This is advantageous in particular with a coupling of a massage system or massage device in a vehicle seat to an entertainment system of a vehicle. An entertainment system of a vehicle normally has a very high service life demand, because it runs continuously in normal use when operating the vehicle. According to the invention, it is thus possible to adapt the service life of the massage system to the service life of the entertainment system without replacing the motors in the massage system, such that a coupling is enabled that is also functional over a long timespan, without increasing the production costs for the massage device.

According to the invention, the increased service life is obtained with conventional, or unmodified electric motors in a massage unit. These can be different types of rotational motors, e.g. electric motors configured as brush or brushless motors, or special vibrating motors, e.g. a so called LRA (Linear Resonant Actuator), or CVM (Coin Vibration Motor) or ERM (eccentric Rotating Mass) actuators, etc. In particular, new or modified motors, or more expensive actuators of another type, are advantageously not needed for adapting the service life and/or noise emissions. With a rotational motor, the motor has an oscillating weight preferably attached to its motor shaft.

The motor can be an oscillating motor with an imbalance mass functioning as the oscillating weight, for example. As a result of the acceleration and deceleration of the motor, or an imbalance mass in the motor, a force is obtained that can be felt by an occupant of the seat, thus massaging the occupant. Furthermore, with longer movements caused by the imbalance of the imbalance mass, vibrations are caused.

In another embodiment, it can also be a motor with a balanced oscillating weight on the motor shaft. By way of example, a rotationally symmetrical body is attached to the motor shaft for this. In this case, a restoring force or restoring torque is caused by the acceleration and deceleration of the motor, or the balanced oscillating weight. Vibrations can be generated by a pulse-like or alternating activation of the motor and continuous acceleration and deceleration of the motor.

Preferably, numerous massage units are integrated in the seat that can be controlled accordingly.

In particular, the individual massage units can be controlled on the basis of an entertainment signal serving as the primary signal, while the secondary signal, based on at least one motor state variable, is added thereto and taken into account by a control device during the activation of the massage units.

Advantageous configurations and further developments can be derived from the dependent claims and from the description with reference to the drawings.

According to one embodiment, the method comprises the following steps: acceleration of the rotation of the motor from an initial position with a first operating parameter that is a function of the entertainment signal; deceleration of the rotation of the motor as a function of the entertainment signal; and further rotation of the motor with a second operating parameter that is a function of the motor state variable. The first and second operating parameters can denote a first and second speed or rotational rate of the motor, or a first and second operating voltage of the motor. In particular, this embodiment relates to a rotational motor. Speed can therefore also be expressed by the rotational rate. An uncontrolled rotation of the motor back to the same position due to gravity when it is not supplied with power, or driven, is prevented by a further rotation of the motor with the second operating parameter, dependent on the state variable, after an acceleration and deceleration phase. As a result, an unbalanced wear to the motor commutator is advantageously avoided.

A control device provides an acceleration signal to activate the motor for acceleration with the first operating parameter. A deceleration signal from the control unit can be provided for decelerating the motor. In another embodiment, the motor can also be short circuited to decelerate it, such that it decelerates automatically.

According to one embodiment, a rotational angle of the motor represents the state variable, which is the basis for the secondary control signal. Thus, after a primary signal is cut off, resulting in a deceleration of the motor, and further rotation to an uncritical or desired rotational angle position and/or until a subsequent acceleration, can be undertaken or continued in a controlled manner. Advantageously, the motor consequently does not remain in an unfavorable position, or an uncontrolled rotation to the same rotational angle position due to gravity is avoided. In this manner, wear to the motor is reduced and distributed evenly, such that the service life is advantageously extended.

According to one embodiment, the motor moves over a rotational angle during the acceleration and deceleration, which is less than a full rotation, starting from the initial position. By way of example, the rotational angle is less than 90°. In particular, the rotational angle can also be smaller, e.g. 1° to 20°. A vibrating or massaging effect is obtained by the reaction forces of the acceleration and deceleration as well as the centripetal force caused by the imbalance during a rotation. Advantageously, a highly variable control can consequently be obtained.

According to one embodiment, the motor is rotated further to an operating position that differs from the initial position. The further rotation following the deceleration results in any further successive acceleration and deceleration taking place in another angular segment. At this point, the motor can again be rotated. In this manner, a uniform wear to a commutator is obtained. Advantageously, this also ensures that the motor will not always return to the same position due to gravity, particularly if it has an imbalance mass. This results on the whole in preventing an imbalanced wear to the motor commutator. The operating position can be a position, for example, that the motor reaches after it has been rotated further, after the deceleration, in the same rotational direction. In particular, the motor can be further accelerated from the operating position, with or without stopping in the operating position. It is possible, but not necessary, to predetermine angular intervals described by, or to be reached during, the further rotation. Other predetermined operating positions are also conceivable, e.g. selected with a random value, which will always result in different target operating positions.

According to one embodiment, the second operating parameter is measured such that the further rotation of the motor cannot be felt by an occupant sitting in the seat. Depending on the design of the oscillating weight and any dampening by a cushioning, the second operating parameter in the form of a second speed may be of a different value. As a result, the measures according to invention for extending the service life can advantageously be implemented without compromising the experience for the occupant, or the comfort of the seat.

According to one embodiment, the motor is stopped after reaching a predetermined operating position. In another embodiment, the motor is stopped after completing a predetermined number of rotations. Optionally or additionally, the motor is stopped after a predetermined first time period. After stopping, i.e. when the motor is at a standstill, the motor is not operated for a predetermined second time period for cooling purposes. Sufficient cooling phases are provided in this manner, reducing the heating of the motor and thus protecting it, or reducing wear. In particular, the operating temperature is reduced in this manner, and/or kept within a predetermined or defined range. Alternatively or additionally, the motor can also be stopped when it reaches a predetermined temperature. As a result, the motors in a seat massage system do not run at high temperatures, or above predetermined operating temperatures, without stopping, thus advantageously increasing the service life of the motors significantly.

A control device distributes levels for controlling the motors of a massage system in the entertainment signal and the respective motor state variable such that not all of the motors of a massage unit provided in a seat react simultaneously to a level. Instead, the motors can be stopped in an alternating manner, thus stopping at different times for the predetermined second time period for cooling purposes. By way of example, the respectively activated motors alternate at each level of the entertainment signal, in a manner similar to that of the lights in a lighting console.

The motors are preferably activated such that the cooling phases of the individual motors can be integrated in a massage program based on the entertainment signal, such that the alternating of the motors cannot be felt, or is not noticeable, by the occupants. By way of example, the active motors alternate with a frequency, or at intervals that cannot be distinguished from the massage by the occupant. As a result, a uniform massaging effect is obtained, despite the alternation.

According to one embodiment, a respective last direction of rotation by the motor is stored. The stored last direction of rotation is retrieved prior to each acceleration, and the motor is then accelerated in the direction opposite the last direction of rotation. The acceleration in the opposite direction of rotation takes place, for example, after the motor has been stopped, or with a re-starting from the initial position, or after a predetermined third time period has elapsed. The motor can be stopped, i.e. brought to a standstill, for example, after reaching a predetermined operating position, or following completion of a predetermined number of rotations, or after a predetermined time period. A change in direction of rotation upon reaching a predetermined operating position without first stopping is also conceivable. By continuously changing the direction of rotation, a longer service life of the motors is advantageously ensured, because the run-time of the motors is also distributed over both directions of rotation. In particular, the motor brushes are preserved through the frequent changing of the direction of rotation, e.g. when massage programs are running.

Optionally or additionally, a change in the direction of rotation can also occur each time a massage program is restarted.

According to another embodiment, the method comprises the following steps: obtaining a load state variable for the motor; and reducing the rotational rate or shutting off the motor when a load is below a predetermined lower limit. In this manner, control of the massage units is adapted to occupancy of the seat and/or a physical shape or size of an occupant, in that the motor of a massage unit that is not subjected to a load is slowed or stopped.

Depending on the occupancy of the seat and/or the physical shape of an occupant, the loads to the different motors of the massage unit are greater, lesser, or not at all. According to the method, a motor of a massage unit that is not in contact with the occupant can be shut off automatically, or its rotational rate can be reduced. With non-rotating motors, instead of the rotational rate, a frequency, e.g. of a linear movement, can be reduced. In particular, the massage function can thus be automatically deactivated in unoccupied seats. Furthermore, this also prevents the motor from running without a load at undesired frequencies, which could cause noticeable noise emissions. As a result, the acoustics of a seat massage system are significantly improved when the massage units are not fully or evenly loaded.

According to one advantageous embodiment, the power consumption of the motor is measured as a load state variable for the motor. A lower limit for the power consumption is predetermined as the lower limit for the load, e.g. by means of a calibration. When the massage units are loaded by the body of an occupant during the massage, the motors of the massage unit function at a specific operating point or in a specific operating range, wherein the power consumption of a motor lies within a specific range above the lower limit. By measuring the power consumption, or monitoring the current, it is therefore possible to determine which massage units are loaded, or in contact with the occupants, and which are not. In this manner, those massage units that are not in contact with the occupant can advantageously be shut off, or run at a reduced rotational rate, in a targeted manner.

According to another embodiment, the rotational rate of the motor is measured as the load state variable of the motor. A limit rotational rate is predetermined as the lower limit for the load, e.g. by means of a calibration. Because the rotational rate of the motor changes depending on the load to the massage unit, the rotational rate can be used as the load state variable by measuring or monitoring it. It is thus possible to determine which massage units are in contact with the occupant, and which are not, through the measurement of the rotational rate. In this manner, those massage units that are not in contact with the occupant can advantageously be shut off, or run at a lower rotational rate.

According to another embodiment, the height of an occupant is obtained as the load state variable for the motor. A minimum height is predetermined as the lower limit for the load. Advantageously, motors of individual massage units can be shut off in a manner adapted to the height of the occupant when the state variable represents the height of the occupant. The height is particularly suitable as the load state variable for motors of the massage units close to an edge of a seat. By way of example, a comparatively smaller occupant who is smaller than a woman in the thirtieth percentile, will not reach, or load, the upper edge of a backrest, or only load it to a certain degree. A comparatively large person, e.g. larger than a man in the seventieth percentile, in contrast, reaches or loads the upper edge of the backrest entirely. The motor in this case is a motor of a massage unit located at the upper edge of a backrest, which is not loaded by small occupants, or only loaded to a slight extent, but is fully loaded by a large occupant.

According to a further development, the height of the occupant is obtained via an input with an input device. Alternatively or additionally, a sensor system is provided, via which the height of the occupant is measured. By way of example, the sensor system can include a camera. Alternatively or additionally, it can include a head position detection sensor. Very precise data regarding the height of the occupant can advantageously be obtained in this manner, such that it is likewise possible to advantageously adapt the control of the motors within a wide range.

According to another embodiment, the position of seat adjustment mechanism is detected for obtaining the height of the occupant, and a height of the occupant is derived from the position of the seat adjustment mechanism. As a result, additional sensors and input by an occupant are advantageously unnecessary. Instead, a conclusion can be drawn through the position of the seat adjustment mechanism regarding the height of the occupant using an appropriate algorithm. By way of example, a longitudinal position, a backrest angle, a raising of the seat, and/or a lowering of the seat can be detected as the positions of a seat adjustment mechanism. As a result, positions of different seat adjustment mechanisms can also be incorporated in the derivation of an occupant's height from the position of the seat adjustment mechanism. By way of example, with large occupants, a longitudinal displacement of the seat toward the rear can be detected, and the motors of all of the massage units will be operated. With smaller occupants, a longitudinal displacement of the seat toward the front can be detected, and the motors of the highest massage elements on the backrest will be shut off

According to one embodiment of a seat assembly, it is provide that the motor is located in the seat such that it is substantially vertical when the seat is in the intended use. A substantially vertical orientation in the intended use is understood to mean that the motor is vertical when the backrest is at a neutral position, and is tilted to a corresponding degree when the seat is tilted forward or backward. When the motor is vertical, its shaft is likewise vertical. The path of an oscillating weight or imbalance mass thus lies in the horizontal plane. In this manner, with a motor in the form of an oscillating motor, it is thus possible to prevent an imbalance mass, and therefore the motor shaft, from automatically rotating to a lowest position due to gravity. As a result, an imbalanced wear to the motor commutator is avoided.

According to a further embodiment of a seat assembly, the motor has a balanced oscillating weight on its motor shaft. By way of example, a rotationally symmetric mass is attached to the motor shaft to form the oscillating weight. Because of the inertia of the oscillating weight, a restoring force is caused by the acceleration and deceleration of the motor. As a result, vibrations can be generated through a pulse-like activation of the motor and a continuous acceleration and deceleration. With a balanced oscillating weight, the problems that arise with an imbalanced mass involving automatic rotation are advantageously eliminated due to the uniform weight distribution.

The embodiments and further developments described above can be combined arbitrarily with one another, insofar as this is useful. In particular, the two aspects of the method comprising a further rotation of the motor following an acceleration and deceleration phase, and the shutting off or reducing the rotational rate of the motor depending on the load, can be combined with one another. Furthermore, all of the features of these aspects of the method can be applied to a control device configured to control at least one motor according to such a method, and to a seat assembly that has such a control device.

Further possible embodiments, further developments and implementations of the invention also comprise not explicitly specified combinations of features of the invention described above or in the following in regard to the exemplary embodiments. In particular, the person skilled in the art will also add individual aspects to the respective fundamental form of the present invention by way of improving or supplementing it.

### BRIEF DESCRIPTION OF THE DRAWINGS

The present invention shall be explained in greater detail below based on the exemplary embodiments shown in the schematic figures in the drawings. Therein:

FIG. 1 shows a flow chart for a method according to a first embodiment;

FIG. 2A shows a schematic illustration of a motor of a massage unit when it is accelerated from an initial position;

FIG. 2B shows a schematic illustration of a motor of a massage unit when it is decelerated from a first speed;

FIG. 2C shows the motor according to FIGS. 2A and 2B when it has been rotated further after deceleration;

FIG. 2D shows the motor according to FIGS. 2A to 2C when it has been stopped after a full rotation;

FIG. 3 shows a flow chart of a method according to another embodiment;

FIG. 4 shows a block diagram of an embodiment of a seat assembly;

FIG. 5A shows a schematic side view of a seat assembly according to a further embodiment, with an occupant;

FIG. 5B shows a schematic side view of the seat assembly according to FIG. 5A, with a comparatively small occupant;

FIG. 6 shows a schematic illustration of the position of a motor of a massage unit in a backrest;

FIG. 7 shows a seat assembly according to another embodiment, with a vehicle seat and a massage device;

FIG. 8 shows a longitudinal sectional view of a vehicle seat with a massage device, which has a group of massage units;

FIG. 9 shows a flow chart of another embodiment of a method.

The attached figures of the drawings are intended to convey a further understanding of the embodiments of the invention. The illustrated embodiments are intended, in combination with the description, for explaining the principles and concepts of the invention. Other embodiments and many of the specified advantages can be derived from the drawings. The elements of the drawings are not necessarily drawn to scale.

Elements, features and components that are identical, have the same function, and act in the same manner, are each provided with the same reference symbols, if not otherwise stated.

### DETAILED DESCRIPTION

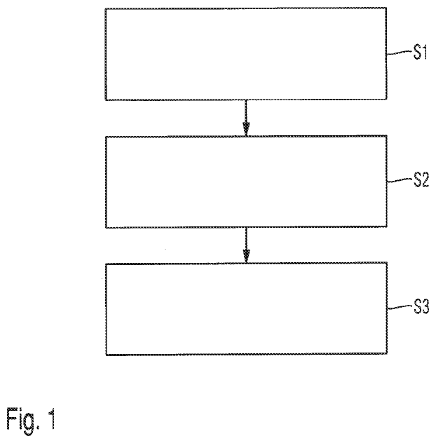

FIG. 1 shows a flow chart for a method according to a first embodiment. This is a method for controlling a motor 20 of a massage unit 2-1 to 2-n provided in a seat 10, in particular a vehicle seat 10. The seat 10 can be a vehicle seat 10, in particular.

The method provides for the acceleration S1 of a rotation of the motor 20 from an initial position with a first operating parameter, in this case to a first speed v1 in particular, as a function of an entertainment signal. The method furthermore provides for deceleration S2 of the rotation of the motor 20, depending on the entertainment signal. Moreover, the method also provides for a further rotation S3 of the motor 20 with a second operating parameter, in this case a second speed v2, in particular, depending on a motor state variable, in this case a rotational angle φ, in particular. Alternatively to a first and second speed v1, v2, the first and second operating parameters can also be a first and second voltage with which the motor 20 is operated.

A force results from the acceleration S1 and deceleration S2 of the motor, which can be felt by an occupant of the seat 10, thus massaging the occupant.

The motor 20 preferably has an oscillating weight. This can be an imbalanced mass or a balanced mass.

Numerous massage units 2-1 to 2-n are preferably integrated in the seat 10 of a seat assembly 30, which are controlled accordingly.

In particular, the individual massage units can be controlled and activated by a control device 6 on the basis of an acoustic entertainment signal 4 serving as the primary signal, and also a secondary signal based on the motor state variable, in particular the rotational angle φ.

The acoustic entertainment signal 4 can be a piece of music, for example, played by a media player 5. In other embodiments this can also be a signal from a video, film, video game, etc. In particular with a vehicle seat, thus when the method is used in a vehicle, the media player 5 can be an entertainment system of the respective vehicle, e.g. comprising a radio, CD player, DVD player, Blu-ray player and/or an MP3 source, or it can be coupled thereto.

The control device 6 controls the motor 20 accordingly, in order to accelerate S1 and decelerate S2 it on the basis of the acoustic entertainment signal. A further rotation S3 takes place independently of the acoustic entertainment signal, and is likewise activated by the control device 6.

A second operating parameter, in this case a second speed v2, is selected for the further rotation such that the movement of the further rotation cannot, or can hardly, be felt by an occupant sitting on the seat 10. The further rotation S3 takes place until the motor is activated by the control device for further acceleration based on the acoustic entertainment signal.

Alternatively to a renewed acceleration, the motor 20 can be stopped when it reaches a predetermined limit, such that it is at a standstill. The motor is not driven when it is at a standstill, and can cool off. The cooling preferably takes place over a predetermined second time period.

A predetermined operating position of the motor, i.e. a predetermined rotational angle φ, can be 90°, 180°, 270°, 360° or a whole number multiple thereof. In the present case, the predetermined operating position is an angular interval of the rotational angle, by way of example, of 180° or 360°, or a whole number multiple thereof. Other predetermined operating positions are likewise possible.

Furthermore, if it is activated by the control device 6 in brief intervals for successive accelerations S1 and decelerations S2, the motor 20 can be stopped after completing a predetermined number of rotations, or after a predetermined first time period, and remain idle for a predetermined second time period for cooling purposes.

Alternatively or additionally, a temperature sensor can be provided on the motor, and the motor can be stopped when it reaches a predetermined temperature, and remain idle for a predetermined second time period for cooling purposes.

A direction of rotation of the motor 20 is always changed after the motor has been stopped. For this, a respective last direction of rotation of the motor is stored, and retrieved prior to an acceleration, such that the motor can be accelerated in the opposite direction of rotation.

The massage units 2-1 to 2-n in a seat assembly 30, each of which has a motor 20, can be distributed over the surface of the seat 10.

Preferably, only a portion of the massage units 2-1 to 2-n integrated in the seat 10 are simultaneously activated with the output signal 7 based on the entertainment signal 4. The control device 6 distributes the levels for activating the motors 20 for this such that not all of the motors 20 of the massage units 2-1 to 2-n provided in a seat 10 react simultaneously to a level. Instead, the control device 6 distributes the levels such that the motors 20 alternate, and can thus be stopped for the predetermined second time period for cooling purposes. The cooling phases of the individual motors 20 are preferably integrated in a harmonious manner into the massage program, such that the alternating of the motors is not noticeable to the occupant.

Lastly, the acoustic entertainment signal 4 can be used as a primary signal or initial value for the activation, in particular independently of the volume set on the media player 5. As a matter of course, the acoustic entertainment signal 4 can also be adapted to the volume of the media player 5, if desired.

An acceleration signal issued from a control device 6 is provided for activating the motor 20 to accelerate S1 to the first speed v1. A deceleration signal can be provided by the control device 6 for decelerating S2 the motor 20.

In another embodiment, the motor can also be short circuited to decelerate it, such that is decelerates automatically.

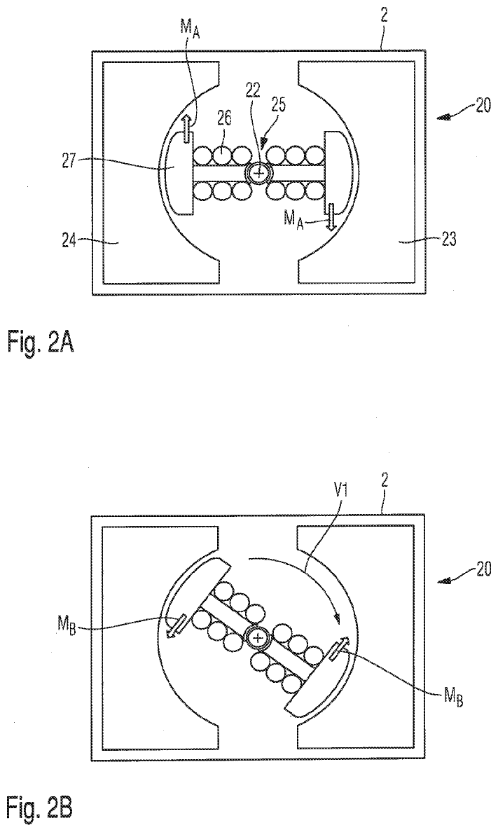

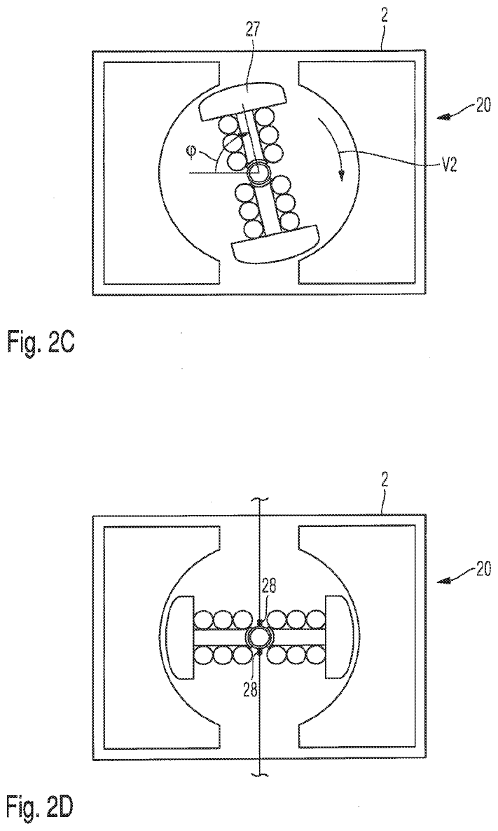

FIG. 2A shows a schematic illustration of a motor 20 of a massage unit 2 when it is accelerating from an initial position.

The motor is configured as an electric motor, wherein a configuration as a permanently excited DC machine is shown here, purely by way of example. Other embodiments of an electric motor are also possible. The motor 20 has a stator with two magnetic poles 23, 24, and a commutator 25 with sliding contacts, not shown here for purposes of clarity. The motor 20 generates a drive torque M_{A} on a motor shaft 22 in a manner known to the person skilled in the art. Windings 26, provided on a rotor 27 or armature connected to the motor shaft 22, are supplied with the appropriate current for this via the commutator 25.

For purposes of clarity, the drive torque M_{A} is indicated here with two opposing arrows on opposite sides of the motor shaft 22, instead of directly on the motor shaft 22.

The position shown as the initial position is to be understood purely as being for illustrative purposes. In particular, the initial position is not necessarily a position oriented perpendicular to the poles, but instead can also be another position.

FIG. 2B shows the motor according to FIG. 2A while decelerating S2 from a first rotational speed v1.

As a result of the acceleration S1, the motor 20 or its rotors achieve a speed or rotational rate or rotational speed v1. The pole of the armature current of the motor applied to the windings 26 can be reversed for deceleration S2, such that the current with reversed polarity generates a braking torque M_{B} acting against the rotation.

For purposes of clarity, the braking torque M_{B} is indicated here by two opposing arrows on opposite sides of the motor shaft 22, instead of directly on the motor shaft 22.

In another embodiment, the motor can also be short circuited to cause the deceleration S2, instead of reversing the polarity. In this case, a current induced by the magnetic field of the stator in the windings 26 of the rotating rotor 27 generates a Lorentz force acting against the rotation, also resulting in a braking torque M_{B} applied to the motor shaft.

FIG. 2C shows the motor according to FIGS. 2A and 2B while rotating further S3 after deceleration S2.

During the further rotation S3 after deceleration S2, the rotor 27 exhibits a second rotational speed v2, which is lower than the first rotational speed v1.

The motor 20 can stop during the deceleration S2, and subsequently rotate further at the second speed v2.

In another embodiment, the rotation of the rotor can also be merely reduced by the deceleration S2 from the first speed v1 to the second speed v2.

The motor 20, or the rotor 27 of the motor 20, travels over a rotational angle φ during the accelerations S1 and decelerations S2, which is smaller than a complete rotation. By way of example, this is a rotational angle of <90°. Purely by way of example, a rotational angle of ca. 75° is indicated here. In particular, the rotational angle that is traveled can also be even smaller, e.g. smaller than 30°, or smaller than 20°, in particular 1° to 20°.

FIG. 2D shows the motor according to FIGS. 2A to 2C, while stopped after a rotation.

In this illustration, brushes 28 of the motor 20 are depicted schematically, which interact with the commutator 25 in a manner known to the person skilled in the art to supply a current to the windings 26.

In the depicted position, the motor 20 is now in a predetermined operating position with a rotational angle of 180°. The position shown as the predetermined operating position is purely illustrative. In particular, the predetermined operating position is not necessarily a position oriented perpendicular to the poles, but instead can also be another predetermined position, in particular with other rotational angles.

Furthermore, the structure of the motor, in particular the type, number and configuration of poles, flukes and windings, are to be understood purely schematically and by way of illustration.

The motor can again be accelerated from the predetermined operating position, in particular in the same manner described in reference to FIG. 2A.

A renewed acceleration from another operating position, in particular without prior stopping, i.e. an acceleration from an operating position during the movement of the further rotation, is also possible.

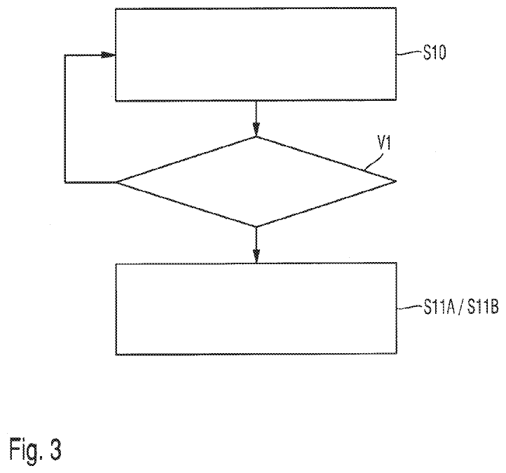

FIG. 3 shows a flow chart for a method according to another embodiment.

This is a method for controlling a motor 20 of a massage unit 2-1 to 2-n provided in a seat 10, in particular a vehicle seat 10. The seat 10 can be a vehicle seat 10 in particular.

The method provides for obtaining S10 a load state variable for the motor 10. Furthermore, the method provides for reducing S11A the rotational rate or shutting off S11B the motor 20 when the load falls below a predetermined lower limit.

The method therefore contains a branching V1 after obtaining S10 the load state variable for the motor 20. The obtaining S10 of the state variable is continued at the branching V1, if the load has not fallen below the lower limit.

If the load falls below the lower limit, either a reduction S11A of the rotational rate, or a shutting off S11B of the motor, is carried out in step S11.

The reduction S11A of the rotational rate of the motor 20 can then take place in particular when the load is less than the predetermined lower limit, but can still be measured.

The motor can be shut off S11B, in particular, when no load can be measured.

Step S11 can thus contain another branching V2, not shown here for purposes of clarity, at which the reduction S11A of the rotational rate of the motor takes place if a load can be measured, and the shutting off S11B of the motor can take place when no load can be measured.

The power consumption of the motor 20 can be measured as the load state variable of the motor 20 in one embodiment, wherein a lower limit for the power consumption is predetermined as the lower limit for the load.

In another embodiment, the rotational rate of the motor 20 can be measured as the load state variable of the motor 20, wherein a limit rotational rate of the motor is predetermined as the lower limit.

The height of an occupant of the seat 10 can also be obtained as a further load state variable, in particular for a motor 20 of a massage unit 2-1 disposed on the edge of a seat 10. A minimum height can be predetermined as the lower limit for the load. In this case, if the occupant is not the minimum height, for example, a motor 20 of a massage unit 2-1 provided on an upper end of a backrest 13 can be stopped, or its rotational rate can be reduced.

The height of the occupant can be obtained either through an input, in particular a manual input by the occupant with an input device. An alternative or additional possibility for obtaining the height comprises a sensor system 21 for measuring the height. Such a sensor system 21 can be implemented by means of a camera in conjunction with an image analysis device or by a head position detection sensor.

Another possibility for obtaining the height of the occupant comprises the detection of a position of a seat adjustment mechanism of the seat 10, wherein the height is derived from the position of the seat adjustment mechanism, which allows for conclusions to be drawn from a seat position set by the occupant. A computing device on which a suitable calculating logarithm for calculating the height is implemented derives the height of the occupant from the position of the seat adjustment mechanism.

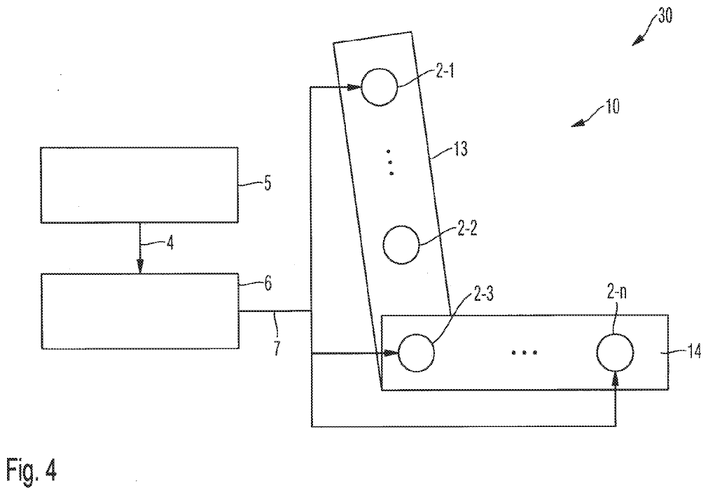

FIG. 4 shows a block diagram of an embodiment of a seat assembly 30.

The seat assembly 30 comprises a seat 10, a media player 5, and a control device 6.

A number, i.e. one or more, of massage units 2-1 to 2-n, in this example, four, purely by way of example, are located in the seat 10. In FIG. 4, merely by way of example, the massage units 2-1 and 2-2 are located in the backrest 3, and the massage units 2-3 and 2-n are located in the seat. Other massage units 2 are indicated by three dots. The number and arrangement of the massage units 2 can be varied according to the application.

The control unit 6 is provided for activating the massage units 2-1 to 2-n, which generates a control signal 7 for the massage units 2-1 to 2-n, derived from an entertainment signal 4 provided by the media player 5, e.g. a piece of music, and conveys it to them.

The entertainment signal 4 can be an audio signal, for example, depicting a piece of music or suchlike. The entertainment signal 4 can come from different sources for this. By way of example, the media player 5 be an audio system installed in the vehicle that contains a radio, CD player, MP3 player, video/DVD/Blu-ray player, etc. The media player 5 can also be an audio system, however, that receives the entertainment signal via Bluetooth, e.g. from a smartphone.

As an alternative to a piece of music, another acoustic primary signal can also function as the initial value, e.g. the sound of a motor recorded from a motor or an artificially generated or imitated motor noise in an electric vehicle.

The control device 6 can either be integrated in the interior of the seat 10, or merely be connected to the seat 10 externally. An external control device 6 can be provided as a software module integrated in a vehicle electrical system control device, for example.

In particular, the control device 6 and the media player 5 can also be consolidated or integrated into a single control device. By way of example, the control device 6 can already be integrated in the vehicle audio system. The massage units 2-1 to 2-n are coupled directly to the media player 5 in one embodiment, which has the necessary activation circuitry for providing the output signal 7. Both the media player 5 and the control device 6 can be configured at least in part as computer program modules that are executed by a computing device in the audio system.

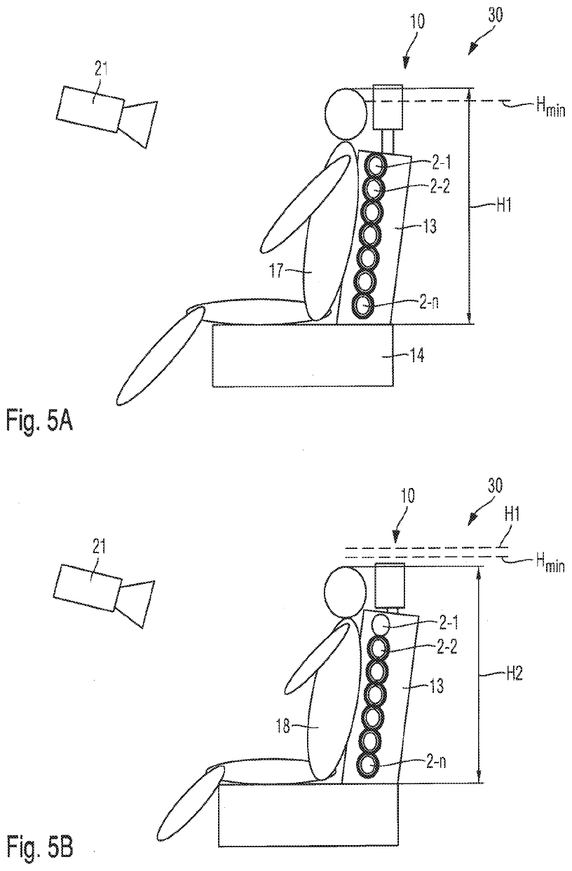

FIG. 5A shows a schematic side view of a seat assembly 30 according to another embodiment, with an occupant.

Purely by way of example, the seat assembly 30 has a seat 10 with massage units 2-1 to 2-n integrated in the backrest 13. Additional massage units can also be provided in the seat 14 and/or in other areas of the seat 10. Furthermore, an arbitrary number of further seats 10 can also be provided.

The massage units 2-1 to 2-n are distributed evenly along the vertical plane of the backrest 13 of the seat 10. Insofar as an occupant 17 with an average or greater than average height H1, shown here, by way of example, in the form of the skull-to-seat length, sits on the seat in the intended manner, its back is in contact with all of the regions of the backrest 13 in which the massage units 2-1 to 2-n are located. Thus, all of the motors 20 of the massage units 2-1 to 2-n are loaded when in operation.

The loads to the motors 20 are determined by obtaining a state variable, as described in reference to FIG. 3. For this, the current and/or the rotational rate of the motors can be monitored. Furthermore, a sensor system 21 is provided, which has a camera, and records, by way of example here, the skull-to-seat length H of the occupant.

In the constellation shown in FIG. 5, the occupant 17 is at least of average or taller than average height H1, which is taller than the minimum height Hmin. Thus, all of the motors are operated in the intended use, as is indicated by the double borders around the massage units 2-1 to 2-n symbolizing vibrations.

FIG. 5B shows a schematic side view of the seat assembly 30 according to FIG. 5A, with a comparatively small occupant 18.

In differing from FIG. 5A, the occupant 18 here is significantly shorter, represented in FIG. 5B by the skull-to-seat length H2. Accordingly, the motors 20 of the upper massage units 2-1 are not loaded, or loaded only slightly, when the comparatively small occupant 18 sits on the seat in the intended manner. The lower load to the motors of the massage unit 2-1 results in a low load state variable obtained for the motors 20. In particular, power consumption of the motor 20 in the massage unit 2-1 is measurably less than with a loaded motor. Furthermore, the rotational rate of the motor 20 in the massage unit 2-1 is measurably higher than in a loaded motor. Furthermore, the sensor system 21 detects the shorter height H2, which is shorter than the minimum height Hmin, by means of the camera.

Thus, with the intended use, the motor 20 in massage unit 2-1 is not operated, or activated, as is indicated by the single line around the massage unit 2-1 in contrast to the double borders around the massage units 2-2 to 2-n symbolizing vibration.

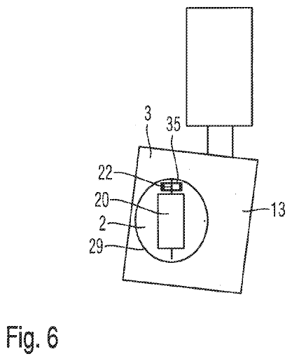

FIG. 6 shows a schematic illustration of the position of a motor 20 of a massage unit 2 in a backrest 13.

The massage unit 2 is integrated in the cushion 3 of the backrest 13, and has a housing 29 and a motor 20 mounted in the housing 29. The motor 20 has a motor shaft, which is vertical in the illustration showing the backrest 13 in a neutral position in the intended use.

An oscillating weight 35 is provided on the motor shaft 22, which is a balanced mass in the form of a rotationally symmetrical cylinder, by way of example.

If the backrest 13 is moved to a more vertical position, the orientation of the motor shaft 22 is shifted from the vertical to the same extent as the movement of the backrest 13 from the neutral position to the more vertical position. The same applies when the backrest 13 is reclined, thus tilting the motor shaft 22 toward the back.

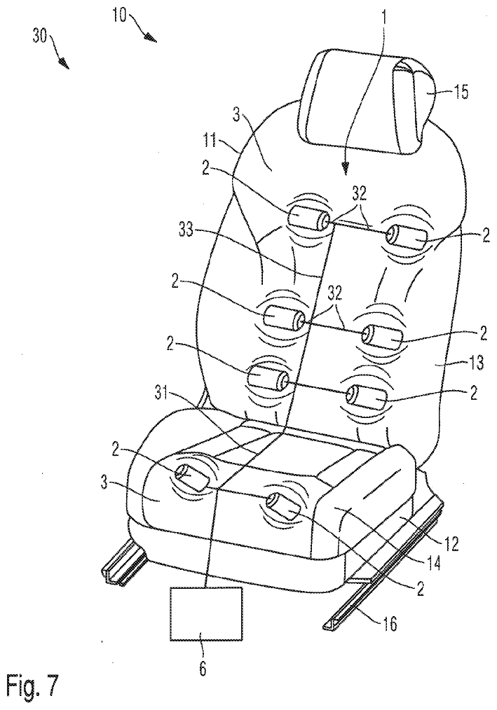

FIG. 7 shows a seat assembly 30 according to another embodiment, with a vehicle seat 10 and a massage device.

The vehicle seat 10 has a seat adjustment mechanism 16, formed by adjustable longitudinal guide rails, purely by way of example. The seat adjustment mechanism 16 can also comprise all of the ergonomic adjustment possibilities of a seat, e.g. a tilt adjustment of the backrest, a seat height adjustment, a headrest adjustment, etc.

A base 12 for the seat 10 is connected to the seat adjustment mechanism 16. The seat 10 also has a seat 13, a backrest 14, and a headrest 15. Other elements can also be provided, e.g. armrests (not shown).

A massage device 1 is integrated in the vehicle seat 10. It has numerous massage units 2, which are implanted in the cushion 3 of the vehicle seat 10. In the embodiment according to FIG. 7, both the seat 13 and the backrest 14 have such a cushion 3 with integrated massage units 2.

Moreover, a control unit 6 is provided, which is provided and configured for controlling all of the massage units 2. By way of example, it can be an external computing device with a corresponding computer program or a control device that supplies the individual massage units with appropriate control signals. The computing device can be, e.g. a vehicle module, in particular a vehicle electrical system control device (body control module).

The control device is configured to detect a position of the seat adjustment mechanism 16 and derive the height of an occupant therefrom. Position sensors can be provided for this on the seat adjustment mechanism 16, for example. The control device 6 can draw a conclusion regarding the height of the occupant from the position of the seat adjustment mechanism by means of an appropriate algorithm implemented thereon. Accordingly, the motors of the uppermost massage units 2 are run at a lower rotational rate, if the height of the occupant is less than a lower limit.

The sensor device 6 can also be coupled to a person-to-machine interface, e.g. an additional keypad, touchscreen operating panel, or the operating unit of an entertainment system of a vehicle. Accordingly, an occupant can operate, or make adjustments to, the massage device 1 via the person-to-machine interface, e.g. by adjusting a frequency distribution to different massage units 2.

Moreover, a connector 31 is provided, which couples the control device 6 to the massage units 2. For this, the connector 31 has a wiring harness 33, into which at least one wire 32 for each massage unit 2 is bundled. The wires 32 branch at those locations where they branch from the wiring harness 33, in particular at the height of the massage units 2 to which they are assigned, and are in contact with the respective massage units 2 in the installed state.

The massage units 2 are individual massage units 2 in the depicted embodiment. The control device 6 controls the acceleration and deceleration as well as the rotational rate of each of the motors 20 integrated in the massage units 2. If the motors 20 are configured as oscillating motors, their vibration frequency can be determined by the rotational rate. Alternatively or additionally, a vibration can be generated through the accelerations and decelerations.

The control device 6 is configured to execute a massage program in which the different massage units 2 are activated for massaging. This can take place, in particular, in accordance with a method described in reference to FIGS. 1 to 5.

The control device is located outside the vehicle seat 10 in the depicted embodiment. In other embodiments, the control device 6 can also be integrated in the vehicle seat 10, e.g. in its base 12 or in the cushion 3. In this case, the control device 6 is an internal computing device.

In order to install the massage device 1 in the vehicle seat 10, the massage units 2 are connected to the wires 32 dedicated to them in the connector 31, and inserted in dedicated cavities 8 in the cushion 3. It is possible thereby to first connect the wires, then insert the massage units, or first insert the massage units, and then connect the wires. Furthermore, it is also possible to insert the massage units and at the same time connect the wires, e.g. by means of sockets provided in the cushion for a form fitting connection. The insertion and wiring of the massage units 2 is done individually here, by way of example.

In a further installation step, the cushion 3 is covered with a seat cover 11. The massage units 2 are thus covered in in the seat 10 in the installed state, in particular entirely.

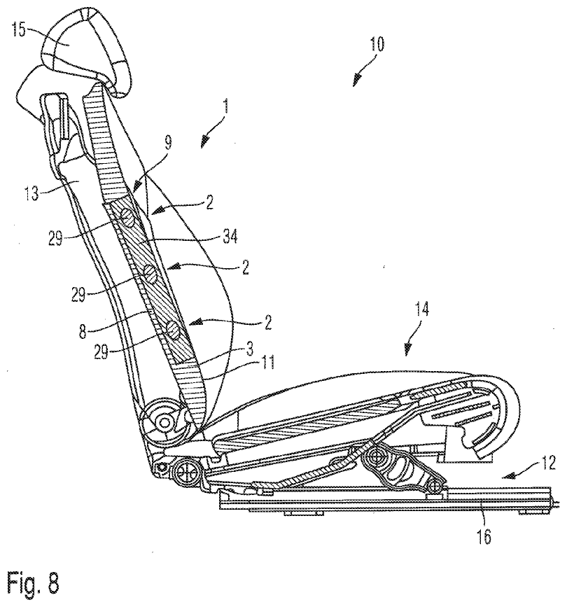

FIG. 8 shows a longitudinal sectional view of a vehicle seat 10 with a massage device 1, which has a group 9 of massage units 2.

In differing from the embodiment according to FIG. 7, the massage units 2 are pre-assembled in groups 9 before the installation. By way of example, groups of massage units 2 are collectively coated in a cushioning foam, and the pre-assembled group 9 is inserted in the cushion 3 of the seat 10 as a foam cushion 34.

The group 9 of massage units 2 is integrated here, by way of example, in the backrest 13 of the vehicle seat 10.

The presently depicted group 9 of three massage units 2 is secured by friction, for example, in a cavity 8 provided for this inside the cushion 3 of the backrest 14.

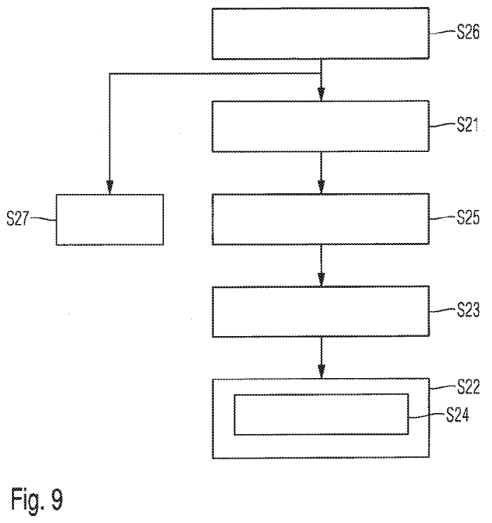

FIG. 9 shows a flow chart for a method for controlling a massage device.

The method comprises steps S21 to S27, and can be combined in particular with the method for controlling a motor of a massage unit according to FIG. 1 or FIG. 3.

The numbering of the individual steps S21-S27 is merely for purposes of distinction, and does not imply a specific sequence. In particular, individual steps can also be carried out at different positions or in different sequences that those depicted below.

The method provides for the playback, S21, of an acoustic entertainment signal 4. The method also provides for the activation S22 of the motors 20 of the massage units 2-1 to 2-n integrated in the seat based on the acoustic entertainment signal 4. In particular, the activation S22 can be provided by means of the method described in reference to FIG. 1, with the steps S1 to S3, and/or in reference to FIG. 3, with the steps S10 and S11 (or S11A/S11B), i.e. as a function of a state variable of the respective motors in the massage units 2-1 to 2-n.

The step S26 prior to step S21 provides that the acoustic entertainment signal 4 is supplied by means of an audio source in the media player 5. The audio signal source can be an audio signal source in particular in the form of a MP3 player, a smartphone, etc. or an audio signal source built into the vehicle, e.g. an integrated CD player, an MP3 source, a video/DVD/Blu-ray player, etc.

After the playback S21 of the acoustic entertainment signal 4, the dynamic curve of the acoustic entertainment signal 4 can be compressed and/or expanded in step S25 to activate the massage units 2-1 to 2-n.

After step S25, various frequency ranges of the acoustic entertainment signal 4 are each converted to an output signal 7. By way of example, different massage units 2-1 to 2-n can be activated with signals of different frequencies. It may also be possible for the user to select the frequencies, or the massage units 2-1 to 2-n that are activated with the respective frequencies. In particular in a vehicle, a type of equalizer can be displayed in the head unit, i.e. a central display and control unit, that can be adjusted by the user. The massage units 2-1 to 2-n can also be activated in groups, collectively. The activation in groups can be distributed evenly, as with the groups 9 for the installation, but this is not necessary.

In parallel to the activation of the massage units 2-1 to 2-n, the acoustic entertainment signal 4 can be played back through a speaker in step S27.

Although the present invention has been fully describe on the basis of preferred exemplary embodiments, it is not limited thereto, and can be modified in a number of ways.

In particular, different types of motors can be used for the massage units, which can generate a vibration through accelerations and decelerations, e.g. so-called LRA (Linear Resonant Actuator) vibration motors, coin-vibration motors, ERM (Eccentric Rotating Mass) actuators, etc.

It is understood that the seat 10 or the seat assembly 30 is not only for use in a vehicle. The seat 10, can also be configured, e.g. as an airplane seat, or a seat in a train or bus, etc.

If the seat assembly 30 is used with numerous seats 10, a separate control device 6 can be provided for each of the seats 10. This is advantageous in particular when there is an individual media player 5 for each seat 10. This is the case, e.g. in airplanes or trains, in which headphones sockets are located in each of the seats, and a user can select an individual audio or video program.

Alternatively or additionally, a central control device 6 can also be provided, which controls all of the seats on the basis of the same entertainment signal.

### LIST OF REFERENCE SYMBOLS

1 massage device

2, 2-1 to 2-n massage unit

3 cushion

4 entertainment signal

5 media player

6 control device

7 output signal

8 cavity

9 group

10 vehicle seat

11 cover

12 base

13 seat

14 backrest

15 headrest

16 guide rail

17, 18 occupant

20 motor

21 sensor system

22 motor shaft

23, 24 pole

25 commutator

26 windings

27 rotor

28 brush

29 housing

30 seat assembly

31 connector

32 wire

33 wiring harness

34 foam cushion

35 oscillating weight

S1-S3 method steps

S10, S11A/S11B method steps

S21-S27 method steps

H1, H2 height

Hmin minimum height

M_{A} drive torque

M_{B} braking torque

1-18. (canceled)

19. A method of controlling a motor of a massage unit for use in a vehicle seat comprising:
rotating the motor from an initial position, at a predetermined acceleration and a first speed, wherein the first speed is based on an entertainment signal;
braking the motor, at a predetermined deceleration based on the entertainment signal; and
rotating the motor, after the braking, in a first rotational direction, at a second speed, to achieve a predetermined rotational angle, wherein the second speed is based on a state variable of the motor.

20. The method of claim 19 further comprising:
storing the first rotational direction of the motor after the stopping step; and
rotating the motor, after the storing step, in a second rotational direction that is opposite to the first.

21. The method of claim 20, wherein the predetermined rotational angle is based on a magnitude of the state variable.

22. The method of claim 21, wherein the predetermined rotational angle of the motor is less than a 360° from the initial position.

23. The method of claim 22, wherein the predetermined rotational angle of the motor is less than 90° from the initial position.

24. The method of claim 20, wherein the second speed is less than a predetermined-threshold speed and wherein the predetermined-threshold speed is associated with a force required to actuate the massage unit.

25. The method of claim 19 further comprising:
stopping the motor in response to the motor reaching a predetermined operational position.

26. The method of claim 19, further comprising:
stopping the motor in response to a predetermined number of rotations of the motor.

27. The method of claim 19, further comprising:
increasing a magnitude of the state variable to increase a power consumption of the motor to a predetermined load threshold; and
reducing a rotational speed of the motor or shutting off the motor in response to the load of the motor falling below the predetermined load threshold.

28. A massage unit for use in a vehicle seat, the massage unit comprising:
a motor; and
a controller is configured to,
rotate the motor from an initial position at a predetermined acceleration and a first speed, wherein the first speed is based on an entertainment signal,
brake the motor at a predetermined deceleration based on the entertainment signal, and
further rotate the motor in a first rotational direction, at a second speed, to achieve a predetermined rotational angle, wherein the second speed is based on a state variable of the motor.

29. The massage unit of claim 28, wherein the controller is further configured to:
rotate the motor from an initial position, at a predetermined acceleration and at a first speed, wherein the first speed is based on the entertainment signal,
brake the motor, at a predetermined deceleration based on an entertainment signal, and
further rotate the motor in a first rotational direction, at a second speed, to achieve a predetermined rotational angle, wherein the second speed is based on the state variable of the motor.

30. The massage unit of claim 29, wherein the controller is further configured to store the first rotational direction of the motor and further rotate the motor in a second rotational direction that is opposite of the first, in response to the motor being stopped.

31. The massage unit of claim 29, wherein the controller is further configured to receive signals indicative of a physical size of an occupant from the motor and wherein the signals are based on a loading state variable of the motor.

32. The massage unit of claim 31, wherein the controller is further configured to receive signals indicative of the physical size of the occupant from a camera, or a head position detection sensor, or both.

33. A seat assembly for use in a vehicle comprising:
a seat;
a massage unit, provided with a motor, disposed in the seat; and
a controller configured to receive signals indicative of a physical size of an occupant from the motor and wherein the signals are based on a loading state variable of the motor.

34. The seat assembly of claim 33, wherein the controller is further configured to determine a minimum physical size of the occupant based on a minimum load of the motor.

35. The seat assembly of claim 33, wherein the controller is further configured to:
rotate the motor from an initial position, at a predetermined acceleration and at a first speed, wherein the first speed is based on the entertainment signal,
brake the motor, at a predetermined deceleration, based on an entertainment signal, and
further rotate the motor in a first rotational direction, at a second speed, to achieve a predetermined rotational angle, wherein the second speed is based on the state variable of the motor.

36. The seat assembly of claim 35, wherein the predetermined rotational angle of the motor is less than a 360° from the initial position.

37. The seat assembly of claim 35, wherein the controller is further configured to store the first rotational direction of the motor and further rotate the motor in a second rotational direction that is opposite of the first rotational direction, in response to the motor being stopped.

38. The seat assembly of claim 33, wherein the motor includes a shaft and a balanced oscillating weight wherein the balanced oscillating weight is disposed on the shaft.
